(19) United States
(12) Patent Application Publication
(10) Pub. No.: US 2010/0009727 A1
(43) Pub. Date: Jan. 14, 2010

(54) Electronic Device

(75) Inventor: Robert C. Presutti, Raleigh, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/171,357

(22) Filed: Jul. 11, 2008

(51) Int. Cl. H04M 1/00

(52) U.S. Cl. 455/575.1

(57) ABSTRACT

An electronic device, such as a clamshell-type device or a slide-type device, senses when a user opens and closes the device. The device renders selected audio files as audible sounds to the user to indicate when the user opens and closes the device.

### TECHNICAL FIELD

The present invention relates generally to electronic devices, and particularly to electronic devices that render audible sounds to a user responsive to predetermined events.

### BACKGROUND

Wireless communication devices, such as clam-shell or slide type cellular telephones, for example, are very popular. With such devices, users may enjoy being able to contact almost anyone most of the time. Most devices include functions and features that facilitate usability. For example, some cellular telephones are configured to activate and de-activate backlighting whenever a user pivots or slides the cellular telephone open or closed, respectively. Other electronic devices, such as laptop computing devices, for example, also perform this function.

Although such features are useful, conventional wisdom dictates that the features added to such devices are functional or practical for the user. For example, activating the lights when a clam-shell cellular telephone is opened allows the user to immediately see the keys on the keypad so that the user may dial a phone number or enter a command. De-activating the lights when the user closes the clam-shell cellular telephone helps to save battery resources.

Manufacturers do not typically provide features for clam-shell or slide type electronic devices that are simply fun for the user. Providing fun features could help a manufacturer to capture a greater share of the market.

### SUMMARY

The present invention provides a system and method of indicating when a user opens and closes an electronic device. The electronic device may be, for example, a clamshell-type device in which two housings are hingedly attached at one end to pivot between an open position and a closed position. Alternatively, the electronic device may be a slider-type device in which two housings slidingly engage with each other to move between the open and closed positions. Regardless of the type of device, the present invention detects when the housings move or transition between the open and closed positions, and then renders selected audio files to the user to indicate the movement.

In one embodiment, in an electronic device including first and second housing sections movable relative to each other between an open position and a closed position, a method of indicating when the housing sections transition between the open and closed positions comprises detecting movement of the first and second housing sections between the open and closed positions, and rendering a first audio file as audible sound to the user to indicate that the electronic device is open.

In one embodiment, the method further comprises detecting movement of the first and second housing sections from the closed position to the open position, and rendering the first audio file as audible sound to the user to indicate that the electronic device has been opened.

The method may further comprise detecting movement of the first and second housing sections from the open position to the closed position, and rendering the first audio file as audible sound to the user to indicate that the electronic device has been closed.

In one embodiment, the method comprises receiving a first predetermined event when the first and second housing sections transition to the open position, and selecting the first audio file based on a user profile responsive to receiving the first predetermined event.

In another embodiment, the method further comprises detecting movement of the first and second housing sections from the open position to the closed position, and rendering a second audio file as audible sound to the user to indicate that the electronic device has been closed.

In such embodiments, the method may further comprise receiving a second predetermined event when the first and second housing sections transition to the closed position, and selecting the second audio file based on a user profile responsive to receiving the second predetermined event.

In one embodiment, an electronic device configured to operate according to the present invention comprises a first housing section and a second housing section configured to move relative to each other between an open position and a closed position, a detector configured to detect when the first and second housings move between the open and closed positions, and a speaker configured to render a first audio file as audible sound to indicate when the first and second housings move between the open and closed positions.

The electronic device further comprises a controller configured to receive a first signal from the detector when the first and second housing sections transition to the open position, and select the first audio file based on a user profile responsive to receiving the first signal.

The detector is also configured to detect movement of the first and second housing sections from the open position to the closed position, and the speaker may also be configured to render the first audio file as audible sound to indicate that the electronic device has been closed.

In one embodiment, the controller is further configured to receive a second signal from the detector when the first and second housing sections transition to the closed position, and select a second audio file based on a user profile responsive to receiving the second signal.

The detector is also configured to detect movement of the first and second housing sections from the open position to the closed position, and the speaker may also be configured to render the second audio file as audible sound to the user to indicate that the electronic device has been closed.

In one embodiment, the first and second housings are configured to pivot relative to one another between the open and closed positions.

In another embodiment, the first and second housings are configured to slide relative to one another between the open and closed positions.

### BRIEF DESCRIPTION OF THE DRAWINGS

FIGS. 1A-1B are perspective views illustrating a clam-shell type cellular telephone configured according to one embodiment of the present invention.

FIG. 2 is a block diagram illustrating some of the component parts of an electronic device configured according to one embodiment of the present invention.

FIG. 3 is a flow diagram illustrating a method of performing one embodiment of the present invention.

FIG. 4 is a flow diagram illustrating a method of performing another embodiment of the present invention.

FIGS. 5A and 5B are perspective views illustrating a portable computing device configured according to one embodiment of the present invention.

FIGS. 6A and 6B are perspective views illustrating a slide-type cellular telephone configured according to one embodiment of the present invention.

### DETAILED DESCRIPTION

The present invention provides an electronic device configured to render audible sounds to a user whenever the user opens or closes the device. In one embodiment, the electronic device comprises a pair of moveably connected housings that move relative to one another between an open position and a closed position. For example, the device may be a clam-shell type electronic device, or a slide-type electronic device, in which a pair of housings pivot or slide relative to each other between open and closed positions. The electronic device detects when the user moves the housings from the closed position to the open position and renders a first audio file to indicate that the device has been open. The device also detects when the user moves the housings from the open position to the closed position, and renders a second audio file to indicate that the device has been closed.

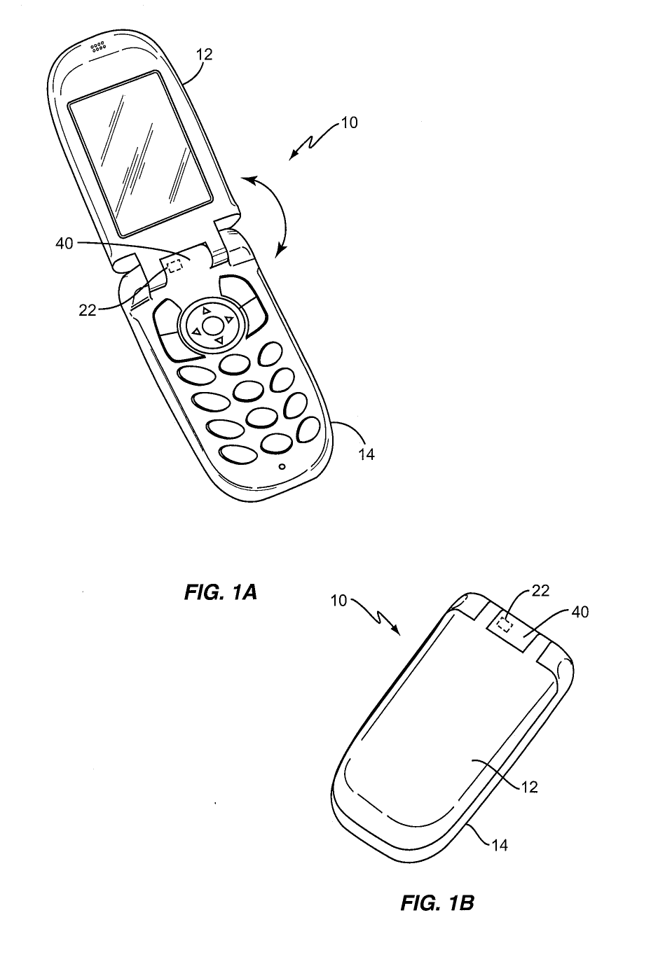

Turning now to the figures, the electronic device may be a clam-shell type cellular telephone 10 such as the one seen in FIGS. 1A and 1B. Cellular telephone 10 typically includes a pair of pivotably connected housings 12, 14. Generally, the housings 12, 14 are pivotably connected at one end by a hinge 40 or other mechanism (not shown) that permits the housings to pivot relative to each other between an open position (FIG. 1A) and a closed position (FIG. 1B). In the open position, a user can perform a wide variety of functions including, but not limited to, placing outgoing calls, answer incoming calls, and navigate a menu system to change the telephone's parameters, maintain address books, and the like. As described in more detail below, a detector 22 may be disposed within the hinge 40 to determine when the first and second housing sections 12, 14 transition to the open position and the closed position.

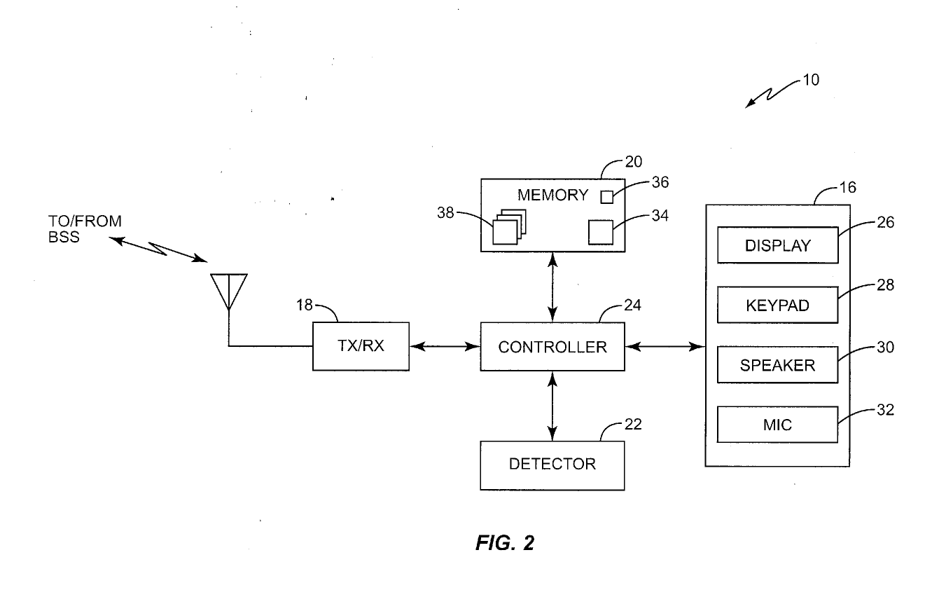

FIG. 2 is a block diagram that illustrates some of the components that may be included in the cellular telephone 10. As described later in more detail, the components are not limited to any specific type of cellular telephone. Rather, such components could be located within any type of cellular telephone, for example, that is configured according to one embodiment of the present invention.

As seen in FIG. 2, the components of cellular telephone 10 may comprise a User Interface (UI) 16, a long-range transceiver 18, a memory 20, a detector 22, and a controller 24. The controller 24 is configured to communicatively connect and control the operation of the UI 16, the transceiver 18, the memory 20, the transceiver 18, and the detector 22.

The UI 16 facilitates user interaction with the cellular telephone 10 and may include any known type of user interface. In this embodiment, the UI 16 comprises a display 26, a keypad 28, one or more speakers 30, and a microphone 32. As is known in the art, the user can control the communication functions of cellular telephone 10 via the UI 16, as well as other functions and features not specifically shown here. For example, the display 26 allows the user to view information such as dialed digits, incoming caller IDs, and menu options. The keypad 28 allows the user to navigate menu systems and to selectively enter the telephone numbers of remote parties and other commands. Speaker 30 renders audible sound to the user, and microphone 32 converts the user's speech into audio signals for transmission to a remote party.

The transceiver 18 allows the user to communicate voice and/or data with one or more remote parties over long and short distances via a wireless communications network. The transceiver 18 may be, for example, a cellular radio transceiver operating according to any known wireless standard. Some examples of suitable standards include, but are not limited to, Wideband Code Division Multiple Access (WCDMA) and Global System for Mobile communications (GSM) standards.

Memory 20 represents the entire hierarchy of memory in the cellular telephone 10, and may include both random access memory (RAM) and read-only memory (ROM). Computer program instructions and data required for operation, such as the operating system (OS) 34, are stored in non-volatile memory, such as EPROM, EEPROM, and/or flash memory, while user data such as user profile 36 and audio files 38, are stored in volatile memory. The OS 34 includes logic and instructions that are invoked whenever the housings 12, 14 transition between the open and closed positions. Particularly, the logic selects an audio file 38 based on user preference information stored in the user profile 36 and renders it through the speaker 30 to indicate when the housings 12, 14 have been open and closed.

Detector 22 is configured to sense whenever the user opens and closes the housings 12, 14. The detector 22, which may comprise any known sensing mechanism such as a switch, for example, may be placed adjacent the hinge 40 that pivotably connects the first and second housings 12, 14. When the housings 12, 14 have attained a first predefined position relative to each other, the detector 22 generates a signal to the controller 24 to indicate that the housings 12, 14 have transitioned from the closed position to the open position. When the housings 12, 14 have attained a second predefined position relative to each other, the detector 22 generates another signal to the controller 24 to indicate that the housings 12, 14 have transitioned from the open position to the closed position.

It should be noted that the figures show a single detector 22. However, the present invention is not so limited. In other embodiments, the detector 22 comprises a pair of detectors. A first detector could detect when the housings 12, 14 transition to the open position, while a second detector could detect when the housings 12, 14 transition to the closed position. In such cases, each of the detectors would generate the appropriate signals to the controller 24 to indicate when the housings 12, 14 have transitioned to the open position and the closed position.

The controller 24, which may be a microprocessor, controls the operation of the cellular telephone 10 based on the application programs and data stored in memory 20. The control functions may be implemented in a single digital signal microprocessor, or in multiple digital signal microprocessors. In one embodiment of the present invention, controller 24 receives the signals generated by the detector 22. In response to the signals, the controller 24 selects a corresponding user-defined audio file 38 based on the user-provided profile information 36 stored in memory 20. Once selected, the controller 24 generates a control signal to render the selected audio file 38 to the user.

Rendering the audio file 38 responsive to opening and closing the housings 12, 14 enhances the user experience. Further, such a feature may separate the cellular telephone 10 from other devices created by rival manufacturers. This could result in increased sales for the manufacturer of cellular telephone 11.

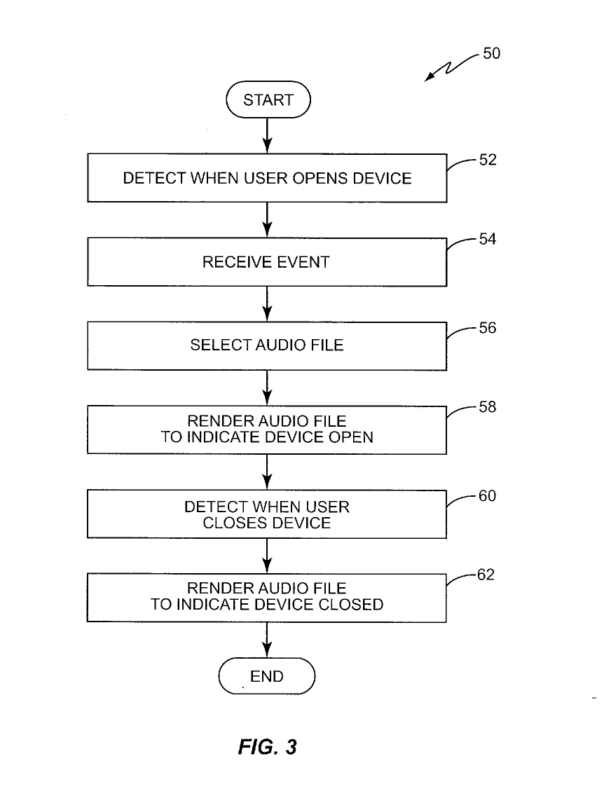

FIG. 3 is a flow diagram illustrating a method 50 of indicating when the housings 12, 14 of the cellular telephone 10 transition between the open and closed positions according to one embodiment of the present invention. Method 50 begins when detector 22 sends a first signal to the controller 24 indicating that the housings 12, 14 have pivoted from the closed position to the open position (box 52). Responsive to receiving the first signal, controller 24 generates a first event message and sends it to the OS 34 logic. The OS 34 logic has an event handler that receives the event messages and invokes a corresponding event (box 54). The event comprises code and instructions that reads the user profile 36 and selects an audio file 38 (box 56). Once the audio file 38 has been identified, the audio file 38 is rendered for the user through speaker 30 (box 58).

The detector 22 then senses when the housings 12, 14 pivot from the open position to the closed position, and generates a second signal to controller 24 (box 60). In response to receiving the second signal, controller 24 generates another control signal to render the selected audio file 38 to the user (box 62).

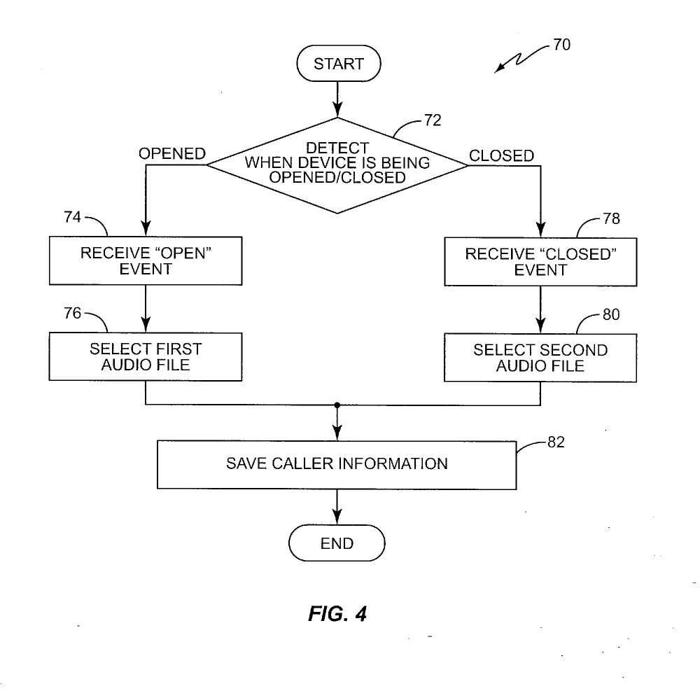

In FIG. 3, the controller 24 renders a single audio file 38 to the user regardless of whether the housings 12, 14 pivot to the open position or the closed position. However, FIG. 4 illustrates another method 70 that renders two different audio files depending on whether the housings 12, 14 are opening, or closing.

As seen in method 70, the controller 24 receives signals from the detector 22, and determines whether those signals indicate that the housings 12, 14 are opening or closing (box 72). If the signals indicate that the housings 12, 14 are pivoting to the open position, the controller generates a first event message for the OS 34 handler. Upon receipt of the first event message (box 74), the appropriate event code reads the user profile 36 to determine a first selected audio file 38 (box 76). However, if the signals indicate that the housings 12, 14 are pivoting to the closed position, the controller 24 generates a second event message for the OS 34 event handler. This second event message is different than the first event message. Upon receipt of the second event message (box 78), the appropriate event code reads the user profile 36 to identify the user-selected audio file 38 (box 80). Regardless of the audio file selected, the controller 24 generates the appropriate control signals to render the selected audio file through the speaker 30 (box 82).

The event messages that are generated responsive to the detector 22 signals may be any event message, and may be in any format, known in the art. For example, in one embodiment of the present invention, controller 24 generates an “ON_EVENT_OPEN” event message to indicate when the housings 12, 14 pivot from the closed position to the open position. Controller 24 also generates an “ON_EVENT_CLOSED” event message to indicate when the housings 12, 14 pivot from the open position to the closed position. Each event message is received by the OS 34 event handler, and has a corresponding event that is invoked to select the appropriate audio file 38 to render to the user. The following table provides some examples of the audio files 38 that may be selected for rendering upon detecting the OPEN and CLOSED event messages.

| EVENT | AUDIO FILE |
|---|---|
| ON_EVENT_OPEN | Audio of a vehicle starting up and speeding |
| | away. |
| | Audio of a vault door unlocking and |
| | opening. |
| | Audio of a roller coaster climbing an initial |
| | track. |
| | Audio of a bowling ball thrown down a |
| | bowling lane. |
| | Audio of a sports announcer saying “The |
| | shot is centered!” |
| ON_EVENT_CLOSED | Audio of a vehicle slamming on the brakes |
| | and screeching to a halt. |
| | Audio of a vault door slamming shut. |
| | Audio of people cresting a hill on the roller |
| | coaster and screaming as they plummet |
| | down the other side. |
| | Audio of ten pins crashing. |
| | Audio of the sports announcer saying, |
| | “GOAL!!!!!” |

Of course, this list is not exhaustive. Other audio files may also be utilized, and may comprise any of a variety of music or sounds.

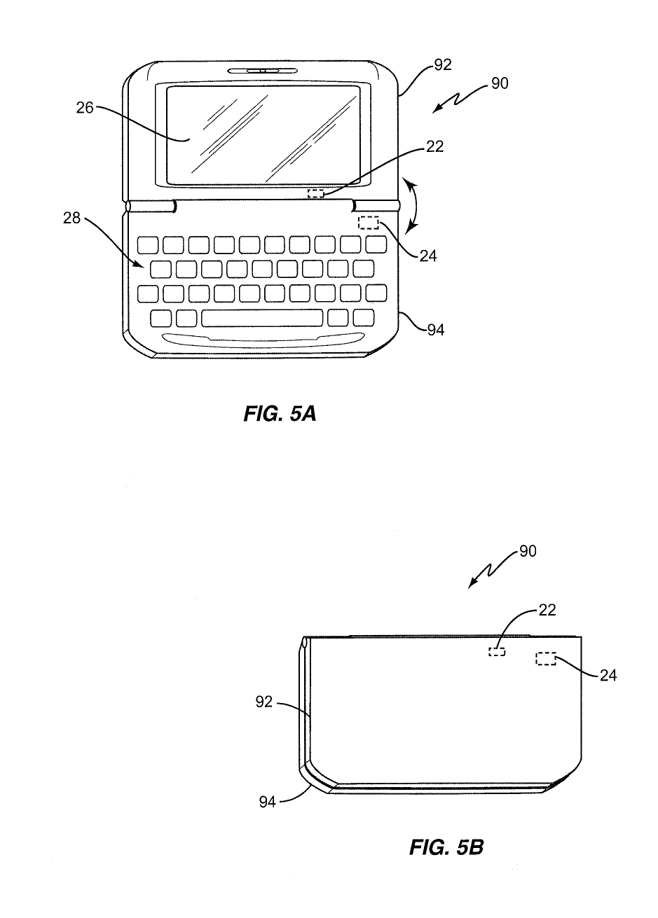

As previously stated, the present invention is not limited to use solely with clamshell type cellular telephones. As seen in FIGS. 5A and 5B, for example, the present invention may be employed in a laptop computing device 90. As is known in the art, the laptop computing device 90 comprises a first housing 92 and a second housing 94 that pivot relative to each other about one or more hinges 96. According to the present invention, the detector 22 senses when the housings 92, 94, transition between the open and closed opsitions and sends the appropriate signals to controller 24. The controller 24 then generates the appropriate event messages and control signals to select the audio files 38 and render them for the user.

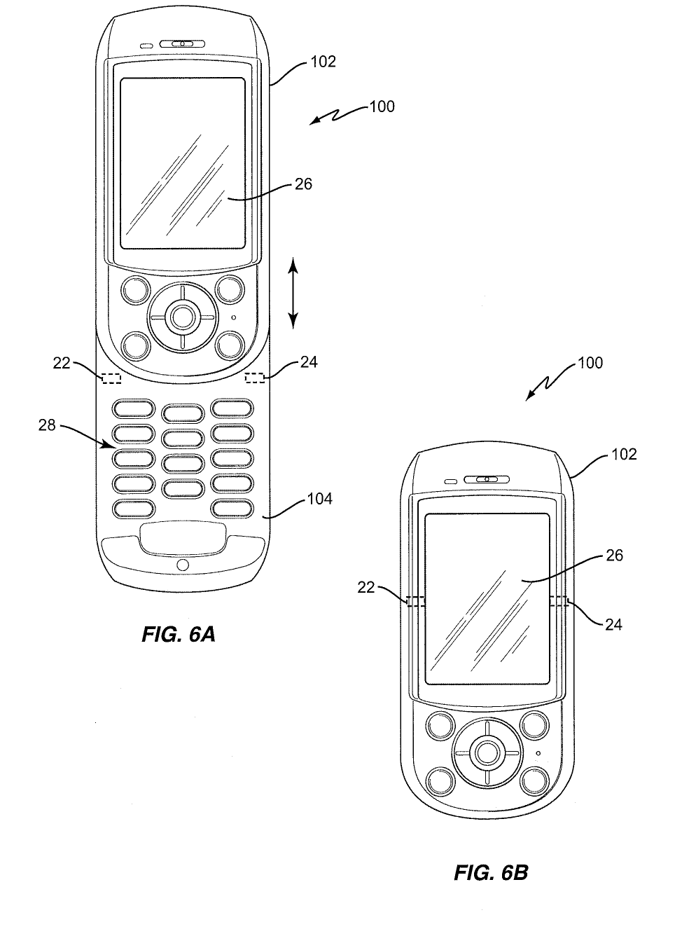

FIGS. 6A and 6B are perspective views of a slide-type wireless communication device 100 that is also configured according to one embodiment of the present invention. The slide-type device 100 comprises a first housing 102 slidably engaged with a second housing 104. There are many ways of slidably connecting the two housings 102, 104, and thus, they are not described here. It is sufficient to understand that the two housings 102, 104 slide relative to each other between the open position (FIG. 6A) and the cloded position (FIG. 6B).

The detector 22 senses when the device 100 slides between the open and closed positions. As above, the detector 22 sends the appropriate signals to the controller 24 to indicate that the device 100 has transitioned to the open or closed position. Upon receipt, the controller 24 generates the event messages to select the predefined audio files 38, and then generates the control signals to render them to the user.

The embodiments of the present invention describe the detector 22 as being a switch. Such a switch could be, for example, a magnetic-based switch that senses a changing magnetic field. Particularly, a magnet could be placed on one housing and a corresponding sensor on the other housing. The sensor would detect whenever the magnet is near, and when the magnet is not, and generate the corresponding signals to the controller 24. The controller 24 would generate the messages and render the selected audio files 38 as previously described.

Other types of switches are also possible. For example, in slide-type electronic devices, the detector 22 may be a contact switch connected to a button or other mechanical actuator that the user employs to open and/or close the device. In this latter embodiment, the contact switch would generate the previously mentioned signals to the controller 24 whenever the user opened or closed the electronic device.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. In an electronic device including first and second housing sections movable relative to each other between an open position and a closed position, a method comprising:
detecting movement of the first and second housing sections between open and closed positions; and
rendering a first audio file as audible sound to the user to indicate that the electronic device is open.

2. The method of claim 1 further comprising:
detecting movement of the first and second housing sections from the closed position to the open position; and
rendering the first audio file as audible sound to the user to indicate that the electronic device has been opened.

3. The method of claim 2 further comprising:
detecting movement of the first and second housing sections from the open position to the closed position; and
rendering the first audio file as audible sound to the user to indicate that the electronic device has been closed.

4. The method of claim 2 further comprising:
receiving a first predetermined event when the first and second housing sections transitions from the closed position to the open position; and
selecting the first audio file based on a user profile responsive to receiving the first predetermined event.

5. The method of claim 2 further comprising:
detecting movement of the first and second housing sections from the open position to the closed position; and
rendering a second audio file as audible sound to the user to indicate that the electronic device has been closed.

6. The method of claim 5 further comprising:
receiving a second predetermined event when the first and second housing sections transition from the open position to the closed position; and
selecting the second audio file based on a user profile responsive to receiving the second predetermined event.

7. An electronic device comprising:
a first housing section and a second housing section configured to move relative to each other between an open position and a closed position;
a detector configured to detect movement of the first and second housings between the open and closed positions; and
a speaker configured to render a first audio file as audible sound to indicate when the first and second housings move between the open and closed positions.

8. The device of claim 7 further comprising a controller configured to:
receive a first signal from the detector when the first and second housing sections transition from the closed position to the open position; and
select the first audio file based on a user profile responsive to receiving the first signal.

9. The device of claim 8 wherein the detector is configured to detect movement of the first and second housing sections from the open position to the closed position, and wherein the speaker is configured to render the first audio file as audible sound to indicate that the electronic device has been closed.

10. The device of claim 8 wherein the controller is further configured to:
receive a second signal from the detector when the first and second housing sections transition from the open position to the closed position; and
select a second audio file based on a user profile responsive to receiving the second signal.

11. The device of claim 10 wherein the detector is further configured to detect movement of the first and second housing sections from the open position to the closed position, and wherein the speaker is further configured to render the second audio file as audible sound to the user to indicate that the electronic device has been closed.

12. The device of claim 7 wherein the first and second housings are configured to pivot relative to one another between the open and closed positions.

13. The device of claim 7 wherein the first and second housings are configured to slide relative to one another between the open and closed positions.
